(19) United States
(12) Patent Application Publication
(10) Pub. No.: US 2012/0073885 A1
(43) Pub. Date: Mar. 29, 2012

(54) Motorized vehicle with expanded solar panel capacity

(75) Inventor: Kenneth P. Glynn, Flemington, NJ (US)

(73) Assignee: Kenergy Development Corp.

(21) Appl. No.: 12/924,249

(22) Filed: Sep. 23, 2010

(51) Int. Cl. B60K 16/00

(52) U.S. Cl. 180/2.2

(57) ABSTRACT

A motorized vehicle having a plurality of solar panels for charging at least one battery, comprises: a) a motorized vehicle having motor power means and having an internal structure to accommodate at least one person, and having an external body structure, the motorized vehicle having a predetermined top-view footprint; b) at least one storage battery having a capacity in excess of the motorized vehicle starting requirements and adapted to power at least one non-starter mechanism; c) a plurality of solar panels having an active solar cell top and a solar cell support bottom, at least one of the plurality of solar panels physically connected to the external body structure of the motor vehicle and electrically connected to the at least one storage battery; the plurality of solar panels having a first position and a second position wherein at least one of the plurality of solar panels is positioned within the footprint in first position and at least one of the plurality of solar panels extends beyond the footprint in the second position, wherein the active solar cell top of all of the plurality of solar panels face upwardly in both the first position and the second position; and d) a solar panel movement mechanism for moving at least one of the plurality of solar panels from the first position to the second position and from the second position to the first position.

### BACKGROUND OF INVENTION

a. Field of Invention

The invention relates generally to motorized vehicles with expanded solar panel capacity for charging a battery. More particularly, it relates to a self powered motorized vehicle with at least one battery and a plurality of solar panels connected to the external body of the motor vehicle and electrically connected to the at least one battery and capable of transitioning between a first position where the solar panels are within a defined footprint and a second position where the solar panels are outside the footprint defined by the first position. This transition may be accomplished manually or automatically

b. Description of Related Art

The following patents are representative of the field pertaining to the present invention:

United States Patent Application No. 2008/0100258 A1 to Thomas A. Ward describes how solar cells are attached to vehicle components such as a moon roof or truck bed cover to create modular solar panels. An adjustable mount can be attached to the solar panels to adjust the angle of the solar cells in a direction of the sun. Sensing for solar tracking the sun angle can be performed using solar cells of the solar panel itself, or a separate sensor. A telescoping moon roof mount mechanism can allow a first solar panel to be extended above a vehicle roof to allow additional solar panels to be telescoped out and also exposed to the sun. An additional battery can be mounted in the truck bed cover and connected in parallel with the hybrid battery.

U.S. Pat. No. 6,423,894 to Werner Pätz et al. describes a motor vehicle roof with a solar generator which is securely attached on the outside on the solid roof skin for producing solar current for the vehicle. The solar generator can be adjusted between a first spatially compact configuration and a second, less spatially compact configuration in which its active solar surface projected onto the plane of the roof is larger than in the first configuration. The invention also relates to a motor vehicle roof with an attachment element which runs in the lengthwise direction of the roof and which is mounted externally on the solid roof skin and which is made such that a mobile flat solar generator can be pushed into the attachment element and is held in the working configuration by it to produce solar current.

U.S. Pat. No. 6,331,031 B1 to Werner Pätz et al. describes a motor vehicle roof with a closure element for a roof opening which can be displaced between a closed position and an open position and which is provided with a primary solar generator. The closure element is made such that an additional element which has an additional solar generator can be coupled to the closure element in the open position of the closure element, such that the additional element assumes a working position on the outside of the vehicle to generate solar current.

U.S. Pat. No. 4,592,436 to Edmardo J. Tomei describes a solar powered vehicle utilizing incident solar radiation to charge storage batteries for energizing an electric motor mounted within the vehicle. The solar panel comprises a lower panel mounted on an exterior surface of the vehicle and first and second upper panels pivotally connected on opposed sides to the lower panel and movable between a first inboard position overlaying the lower panel and a second outboard position in-line with the lower panel in which the lower panel and the first and second upper panels are disposed for receiving incident solar radiation. The first and second upper panels are releasably interlockable with the lower panel in a secure, spaced-apart position when the first and second upper panels are disposed in the first inboard position overlying the lower panel. A plurality of solar panels may be provided on the roof, hood and/or trunk of the vehicle.

U.S. Pat. No. 4,421,943 to Eric M. Withjack et al. describes an apparatus for collecting solar energy and converting it to electrical energy utilizing solar panels pivotally mounted to a base such that the panels may be pivoted to a storage position inside said base. Additional solar panels may be pivotally mounted on retractable frame trays which stow inside the base when the panels are pivoted to a horizontal position.

Notwithstanding the prior art, the present invention is neither taught nor rendered obvious thereby.

### SUMMARY OF INVENTION

The present invention motorized vehicle having a plurality of solar panels for charging at least one battery, comprises: a) a motorized vehicle having motor power means and having an internal structure to accommodate at least one person, and having an external body structure, the motorized vehicle having a predetermined top-view footprint; b) at least one storage battery having a capacity in excess of the motorized vehicle starting requirements and adapted to power at least one non-starter mechanism; c) a plurality of solar panels having an active solar cell top and a solar cell support bottom, at least one of the plurality of solar panels physically connected to the external body structure of the motor vehicle and electrically connected to the at least one storage battery; the plurality of solar panels having a first position and a second position wherein at least one of the plurality of solar panels is positioned within the footprint in first position and at least one of the plurality of solar panels extends beyond the footprint in the second position, wherein the active solar cell top of all of the plurality of solar panels face upwardly in both the first position and the second position; and d) a solar panel movement mechanism for moving at least one of the plurality of solar panels from the first position to the second position and from the second position to the first position.

In some preferred embodiments of the motorized vehicle having a plurality of solar panels for charging at least one battery, the solar panel movement mechanism includes a drive mechanism selected from the group consisting of pneumatic, hydraulic, mechanical, or magnetic drive mechanisms and combinations thereof.

In some preferred embodiments of the motorized vehicle having a plurality of solar panels for charging at least one battery, the solar panel movement mechanism is a rotational movement mechanism that moves solar panels from the first position to the second position.

In some preferred embodiments, the motorized vehicle having a plurality of solar panels for charging at least one battery further comprises at least one post mounted on the exterior body structure of the motor vehicle, wherein at least one of the plurality of solar panels is rotatably attached to the at least one post.

In some preferred embodiments of the motorized vehicle having a plurality of solar panels for charging at least one battery, the solar panel movement mechanism is a telescopic movement mechanism that moves solar panels from the first position to the second position.

In some preferred embodiments of the motorized vehicle having a plurality of solar panels for charging at least one battery, each solar panel of the plurality is positioned over one another in the first position.

In some preferred embodiments, the motorized vehicle having a plurality of solar panels for charging at least one battery further comprises a first and second post mounted on the exterior body structure of the motor vehicle, wherein the at least one solar panel comprises two or more solar panels, wherein the two or more solar panels are divided into a first and a second group, the first group rotatably attached to the first post, and the second group rotatably attached to the second post.

In some preferred embodiments, the motorized vehicle having a plurality of solar panels for charging at least one battery further comprises a plurality of posts mounted on the exterior body structure of the motor vehicle, wherein the plurality of solar panels comprises a plurality of groups, the plurality of groups rotatably attached to the plurality of posts.

In some preferred embodiments, the motorized vehicle having a plurality of solar panels for charging at least one battery further comprises: a base member attached to the solar cell support bottom of least one of the plurality of solar panels; and at least one base member movement mechanism having a top attached to the base member and a bottom attached to the external body structure of the motor vehicle.

In some preferred embodiments of the motorized vehicle having a plurality of solar panels for charging at least one battery, the base member movement mechanism is adapted to rotate the base member along at least two axes.

In some preferred embodiments of the motorized vehicle having a plurality of solar panels for charging at least one battery, an ancillary electronic device is connected to at least one storage battery wherein electricity is supplied to the ancillary electronic device through the plurality of solar panels generating electricity through the at least one storage battery.

In another embodiment of the present invention, a motorized vehicle having a plurality of solar panels for charging at least one battery comprises: a) a motorized vehicle having motor power means and having an internal structure to accommodate at least one person, and having an external body structure, the motorized vehicle having a predetermined top-view footprint; b) at least one storage battery having a capacity in excess of the motorized vehicle starting requirements and adapted to power at least one non-starter mechanism; c) a plurality of solar panels having an active solar cell top and a solar cell support bottom, at least one of the plurality of solar panels physically connected to the external body structure of the motor vehicle and electrically connected to the at least one storage battery; the plurality of solar panels having a first position and a second position wherein at least one of the plurality of solar panels is positioned within the footprint in first position and at least one of the plurality of solar panels extends beyond the footprint in the second position, wherein the active solar cell top of all of the plurality of solar panels face upwardly in both the first position and the second position; and d) a solar panel movement mechanism for moving at least one of the plurality of solar panels from the first position to the second position and from the second position to the first position; and e) a solar panel angle adjustment mechanism attached to at least one of the plurality of solar panels for adjusting the X, Y and Z axis angles of at least one of the plurality of solar panels to enhance solar orientation.

In some preferred embodiments of the motorized vehicle having a plurality of solar panels for charging at least one battery, the solar panel movement mechanism includes a drive mechanism selected from the group consisting of pneumatic, hydraulic, mechanical, or magnetic drive mechanisms and combinations thereof.

In some preferred embodiments of the motorized vehicle having a plurality of solar panels for charging at least one battery, the solar panel movement mechanism is a rotational movement mechanism that moves solar panels from the first position to the second position.

In some preferred embodiments, the motorized vehicle having a plurality of solar panels for charging at least one battery further comprises at least one post mounted on the exterior body structure of the motor vehicle, wherein at least one of the plurality of solar panels is rotatably attached to the at least one post.

In some preferred embodiments of the motorized vehicle having a plurality of solar panels for charging at least one battery, the solar panel movement mechanism is a telescopic movement mechanism that moves solar panels from the first position to the second position.

In some preferred embodiments of the motorized vehicle having a plurality of solar panels for charging at least one battery, each solar panel of the plurality is positioned over one another in the first position.

In some preferred embodiments, the motorized vehicle having a plurality of solar panels for charging at least one battery further comprises a first and second post mounted on the exterior body structure of the motor vehicle, wherein the at least one solar panel comprises two or more solar panels, wherein the two or more solar panels are divided into a first and a second group, the first group rotatably attached to the first post, and the second group rotatably attached to the second post.

In some preferred embodiments, the motorized vehicle having a plurality of solar panels for charging at least one battery further comprises a plurality of posts mounted on the exterior body structure of the motor vehicle, wherein the plurality of solar panels comprises a plurality of groups, the plurality of groups rotatably attached to the plurality of posts.

In some preferred embodiments, the motorized vehicle having a plurality of solar panels for charging at least one battery further comprises: a base member attached to the solar cell support bottom of least one of the plurality of solar panels; and at least one base member movement mechanism having a top attached to the base member and a bottom attached to the external body structure of the motor vehicle.

In some preferred embodiments of the motorized vehicle having a plurality of solar panels for charging at least one battery, the base member movement mechanism is adapted to rotate the base member along at least two axes.

In some preferred embodiments of the motorized vehicle having a plurality of solar panels for charging at least one battery, an ancillary electronic device is connected to at least one storage battery wherein electricity is supplied to the ancillary electronic device through the plurality of solar panels generating electricity through the at least one storage battery.

In another embodiment of the present invention, a motorized vehicle having a plurality of solar panels for charging at least one battery comprises: a) a motorized vehicle having a motor power means and having an internal structure to accommodate at least one person, and having an external body structure, the motorized vehicle having a predetermined top-view footprint; b) at least one storage battery having a capacity in excess of the motorized vehicle starting requirements and adapted to power at least one starter mechanism; c) a plurality of solar panels movably connected to the external body structure of the motor vehicle and electrically connected to the storage battery, each of the plurality of solar panels having a top, wherein each the top of the plurality of solar panels is oriented skyward; the plurality of solar panels having a first position and a second position wherein the plurality of solar panels remains within the footprint in first position and the plurality of solar panels extends beyond the footprint in the second position; d) mechanism means for moving the at least one solar panel from the first position to the second position and from the second position to the first position; and e) means for automatically adjusting the angle of at least one of the plurality of solar panels.

In some preferred embodiments of the motorized vehicle having a plurality of solar panels for charging at least one battery, the means for automatically adjusting the angle comprises: an angle-adjustment means for adjusting the angle of the at least one of the plurality of solar panels; a global positioning system connected to the vehicle, the global positioning system adapted to determining the position and orientation of the vehicle; a computer, computationally connected between the global positioning system and the angle-adjustment means, the computer adapted to receive input, determine the position of the sun based on the input, and output to the angle-adjustment means; a clock computationally connected to the computer; and a calendar computationally connected to the computer.

In some preferred embodiments of the motorized vehicle having a plurality of solar panels for charging at least one battery, the means for automatically adjusting the angle comprises: an angle-adjustment means for adjusting the angle of the at least one of the plurality of solar panels; and a computer, computationally connected to the angle-adjustment means and the plurality of solar panels, the computer adapted to receive input from the plurality of solar panels, determine the position of the sun based on the input, and output to the angle-adjustment means.

In another embodiment of the present invention, in combination, a motorized vehicle and a plurality of solar panels for charging batteries comprises: a) a motorized vehicle having a motor power means and having an internal structure to accommodate at least one person, and having an external body structure, the motorized vehicle having a predetermined top-view footprint; b) a base support connected to the external body structure; c) at least one storage battery connected to the motorized vehicle, the battery having a capacity in excess of the motorized vehicle starting requirements and adapted to power at least one starter mechanism; d) a plurality of solar panels movably connected to the base support and electrically connected to the storage battery, each of the plurality of solar panels having a top and a bottom, wherein each the top of the plurality of solar panels is oriented skyward; the plurality of solar panels having a first position and a second position wherein the plurality of solar panels remains within the footprint in first position and the plurality of solar panels extends beyond the footprint in the second position; e) mechanism means for moving the at least one solar panel from the first position to the second position and from the second position to the first position; and f) means for automatically adjusting the angle of at least one of the plurality of solar panels.

In some preferred embodiments of the present invention combination motorized vehicle and a plurality of solar panels for charging batteries the base support comprises: i) a baseplate having a top adapted to receive the plurality of solar panels, and a bottom; iii) an upper universal joint having a top and a bottom, the top of the upper universal joint attached to the bottom of the baseplate; and iii) at least one elevator having a top and a bottom; the top of the at least one elevator attached to the bottom of the upper universal joint, the bottom of the elevator attached to the external body structure.

In some preferred embodiments of the present invention combination motorized vehicle and a plurality of solar panels for charging batteries the at least one elevator comprises at least one piston.

In some preferred embodiments of the present invention combination motorized vehicle and a plurality of solar panels for charging batteries, the piston is selected from the group consisting of hydraulic, pneumatic, mechanical, or magnetic.

In some preferred embodiments of the present invention combination, the motorized vehicle and a plurality of solar panels for charging batteries further comprises a means for moving the upper universal joint, wherein the at least one elevator comprises a single central elevator.

In some preferred embodiments of the present invention combination motorized vehicle and a plurality of solar panels for charging batteries, the means for moving the upper universal joint comprises manual control.

In some preferred embodiments of the present invention combination motorized vehicle and a plurality of solar panels for charging batteries, the means for moving the upper universal joint comprises automatic control.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 shows a side view and

FIG. 2 shows a top view of an embodiment of a motorized vehicle with expanded solar capacity according to the present invention, illustrating solar panels in a first, closed position;

FIG. 3 shows a top view and

FIG. 4 shows a side view of the motorized vehicle with expanded solar capacity of FIG. 1, illustrating the solar panels of FIG. 1 in an intermediate, partially-opened position;

FIG. 5 shows a top view of the motorized vehicle with expanded solar capacity of FIG. 1, illustrating the solar panels of FIG. 1 in a second, fully-opened position;

FIG. 6 is a partially-transparent top view of another embodiment of a motorized vehicle with expanded solar capacity;

FIG. 7 shows a top view of the motorized vehicle with expanded solar capacity of FIG. 6, illustrating the solar panels of FIG. 6 in a second, filly-opened position;

FIG. 8 shows a flowchart of the motorized vehicle with expanded solar capacity;

FIG. 9 shows a partially-transparent top view of another embodiment of a motorized vehicle with expanded solar capacity, illustrating solar panels in a first, closed position;

FIG. 10 shows a side view of the motorized vehicle with expanded solar capacity of FIG. 9, illustrating the solar panels in a first, closed position;

FIG. 11 shows a top view of the motorized vehicle having expanded solar capacity of FIG. 9, illustrating the solar panels in a second, open position;

FIG. 12 shows a side view of the motorized vehicle with expanded solar capacity of FIG. 9, illustrating the solar panels in a second, open position;

FIG. 13 shows a partially-transparent top view of another embodiment of a motorized vehicle with expanded solar capacity, illustrating solar panels in a first, closed position;

FIG. 14 shows a side view of the motorized vehicle with expanded solar capacity of FIG. 13, illustrating the solar panels in a first, closed position and illustrating the base support under the panels;

FIG. 15 shows a perspective view of one embodiment of the base support, illustrating the base support movement mechanism;

FIG. 16 shows a side view of another embodiment of the motorized vehicle with expanded solar capacity, illustrating the solar panels in a first, closed position and illustrating the base support under the panels;

FIG. 17 shows a perspective view of the embodiment of the base support from FIG. 16, illustrating slidable panels on the base support and telescoping base support movement mechanisms;

FIG. 18 shows a top view of another embodiment of the motorized water vehicle with expanded solar capacity, illustrating the solar panels in a first, closed configuration; and,

FIG. 19 shows a top view of the motorized water vehicle with expanded solar capacity of FIG. 18, illustrating the solar panels in a second, open configuration.

### DETAILED DESCRIPTION OF THE EMBODIMENTS

In recent years, there has been a rise in the popularity of motor vehicles with alternative means of propulsion. The traditional internal combustion and diesel engines have been supplemented with hybrid vehicles that combine an internal combustion vehicle with an electric motor. Fully electric vehicles have also been devised that can draw power from a bank of batteries, which in turn draws power from another source. Fuel cells provide one source of power for newer motor vehicles. Many vehicles sold today are equipped with electrical devices such as a sound system, power windows and door locks, alarm systems, and HVAC systems. Some vehicles also have GPS navigation systems, televisions, and wireless communication technology. Furthermore, passengers in the vehicle may carry personal electronic devices such as mobile telephones, portable video game systems, or laptop computers, which are charged from the vehicle's electrical system.

There has also been a rise in ancillary electrical devices using the electrical systems of motor vehicles. These devices are not part of the vehicle's systems. They instead provide some other service to the users. Professional services such as steam cleaners and septic system drainage trucks use powerful ancillary devices that run off a vehicle's electrical systems. Another example is a broadcast truck that transmits an electromagnetic signal. Another example is a powerful winch attached to a vehicle. Although these devices are not integrated into the motor vehicle, they may still be charged from the vehicle's electrical systems. Often, these professional vehicles have a supplemental electrical system that is separate from the vehicle's primary electrical system.

As demand on the vehicle's primary electrical systems, ancillary electrical systems, and electrical vehicular power increase, it is desirable to have a supplemental system for providing electrical energy to the vehicle. Such systems preferably include some manner of storing energy for later use. This storage may be accomplished through the use of batteries, capacitors, or through mechanical storage such as a flywheel. The system also includes a manner of generating electricity and supplying this electricity to the batteries. In the most preferred embodiments, there is also a system to regulate the stored power. One way to generate the electricity for the batteries is to include solar panels on the vehicle. When sunlight strikes these solar panels, the panels convert the energy into electricity. Because the sun is an energy source that is available throughout the world, it is particularly well-suited as an energy source for a motor vehicle. The present invention provides a motorized vehicle with expanded solar capacity.

The invention solves the problems and overcomes the drawbacks and deficiencies of the prior art by providing a motorized vehicle with solar panels for charging at least one battery. The invention includes one or more solar panels, each of which has an active side covered with solar cells, and a support bottom that provides structural strength and a backing for the solar cells to be mounted on. At least one of these solar panels is physically connected to the vehicle. Also, the solar panels are electrically connected to the storage battery or batteries. The vehicle can be equipped with as many solar panels as the physical structure of the vehicle can support.

The solar panels are movable between a first position and a second position. In the first position, the solar cells a positioned within the top-view footprint of the vehicle. In the second position, the solar cells extend beyond the top-view footprint of the vehicle. In both of these positions, the solar cells face upward. The active solar cell side of the panels faces the sky rather than the ground; however, this does not mean that the panel must be level. In some embodiments, each panel is plane-parallel to each of the other panels. In other embodiments, the panels are angled at varying degrees. In various embodiments, the movement between the first and second position is toward the front of the vehicle, the back of the vehicle, the left side, the right side, or any combination of these directions.

The invention supports the use of multiple movement mechanisms, so in some embodiments there will be multiple solar panels attached to multiple movement mechanisms. This allows different solar panels to move in different directions and to cover a larger area when in the second position. The invention also supports embodiments in which the same solar panel is attached to more than one movement mechanism. This embodiment would allow the solar panel or panels in the second position to be on the left or right side of the vehicle, which could be desirable because parallel-parked cars often have traffic moving past their right or left side.

In some embodiments of the invention, the solar panels in the first position all lie over one another such that when the vehicle is viewed from above, only one of the panels is visible. In other embodiments, the solar panels is split into two or more groups, and in each of these groups, the solar panels in the first position lie over one another, such that when the vehicle is viewed from above, only one panel of each group is visible.

In still other embodiments, the invention includes a base member which provides a structure on which to mount the solar panels. In other embodiments the movement mechanism or mechanisms is attached to this base member. In some embodiments the base member is removably attached to the vehicle's external body structure; in others the base member is permanently connected. In some embodiments, the base member tilts along at least two axes allowing the array of solar panels attached to the base member to move in relation to the vehicle. In still other embodiments, this tilting motion is accompanied by rotation in the third axis. In some embodiments, the movement of the base member is accomplished using a single point of attachment—such as a pillar—that is attached to the base member using a movable connection such as a motorized universal joint. In other embodiments, the base member moves through two points of attachment, such as two pillars with motorized universal joints, although to tilt the base member in two directions will require using telescoping pillars or elevators with powered universal joints on top. In still other embodiments, the rotation of the base member is accomplished using at least three elevators. Each of the elevators in this embodiment would have an unpowered universal joint on top.

In some embodiments, the invention also includes a mechanism to move at least one of the solar panels in three dimensions, allowing at least one of the solar panels to point more closely toward the sun or other light source. This allows the solar panel to move independently of the vehicle or the base member. In other embodiments, there is a mechanism to move all of the solar panels in three dimensions, though this does not require that the panels move together.

In some embodiments, the movement of the panels or of the base member is determined by a computer capable of telling the date and time that is connected to a GPS unit. In these embodiments, after the user enters a command, by pushing a button for example, the computer will communicate with the GPS to determine the vehicle's position and orientation. The computer cross-references the date and time with the car's location and direction to determine the location of the sun and sends a signal to the movement mechanism. This movement mechanism then moves the base member or the solar panels into a sun-facing orientation. In some embodiments the computer will be in constant communication with the GPS and the movement mechanism, allowing for constant adjustment of the panels. In other embodiments, the computer will cycle its communication to preserve power, and will move the panels less frequently. For example, in one embodiment the computer readjusts the panels once per hour.

In some embodiments, the movement mechanism for the base member and the solar panels receives input from a solar tracker. In these embodiments, a device is included to determine from which direction the strongest sunlight is coming. The device then sends a signal to the movement mechanism for the base member, the solar panels, or both.

In other embodiments, the base member can be adjusted manually through a joystick or similar control. This joystick would send a signal to the base member movement mechanism. In other embodiments, a joystick can be used to control one or more of the solar panels through a solar panel movement mechanism. More than one solar panel can be controlled using the same joystick if a selector device, such as a number pad, is employed to change the functionality of the joystick and allow it to control a different solar panel.

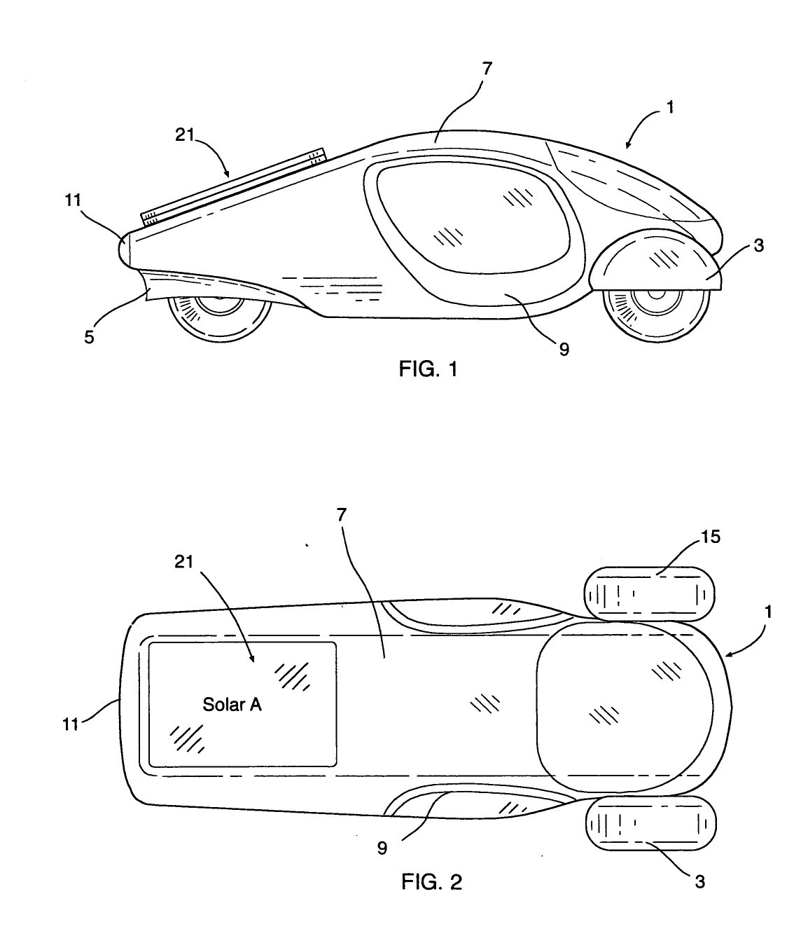

Referring now to FIGS. 1 through 5, wherein like reference numerals designate corresponding parts throughout the several views, it is to be understood that not all numbers appear in all figures. FIG. 1 shows a three-wheeled passenger vehicle 1. In one preferred embodiment, the vehicle 1 is electrically powered. In another preferred embodiment, the vehicle 1 is powered by a fuel cell, not shown. In another preferred embodiment, the vehicle 1 is powered by a hybrid engine, not shown. In another preferred embodiment, the vehicle 1 is powered by an internal combustion engine not shown. The vehicle has at least one energy storage device (not shown), such as a battery, capacitor, or flywheel. The figure shows that the vehicle 1 has a right front wheel 3 and a rear wheel 5. The vehicle 1 also has a left front wheel 15, visible in FIG. 2. The vehicle 1 has an external body structure 7 and a door 9 which together define an interior space that can accommodate at least one person. The vehicle 1 has a rear bumper 11. The vehicle 1 also has a plurality of solar panels 21 mounted on the external body structure 7 of the vehicle 1. The plurality of solar panels 21 are connected to the at least one energy storage device. In addition to starting the vehicle 1, the at least one energy storage device (not shown) can provide power to the vehicle's non-starter mechanisms and to other electrical devices.

FIG. 2 shows another view of the vehicle 1. This top view shows that the vehicle 1 has a left front wheel 15 in addition to the right front wheel 3. Again, the external body structure 7 of the vehicle 1 is shown, along with the door 9. The plurality of solar panels 21 is visible, with the top panel, marked Solar A 25, shown. The plurality of solar panels 21 lies in front of the rear bumper 11, and as seen in FIG. 2, falls within the top-view footprint of the vehicle 1. As used herein, the top-view footprint of the vehicle is the perimeter of the largest cross-section of the vehicle 1 when viewed from directly above; however, the top-view footprint does not include the plurality of solar panels 21. In other words, “top-view footprint” means the footprint of the vehicle 1 without any solar panels.

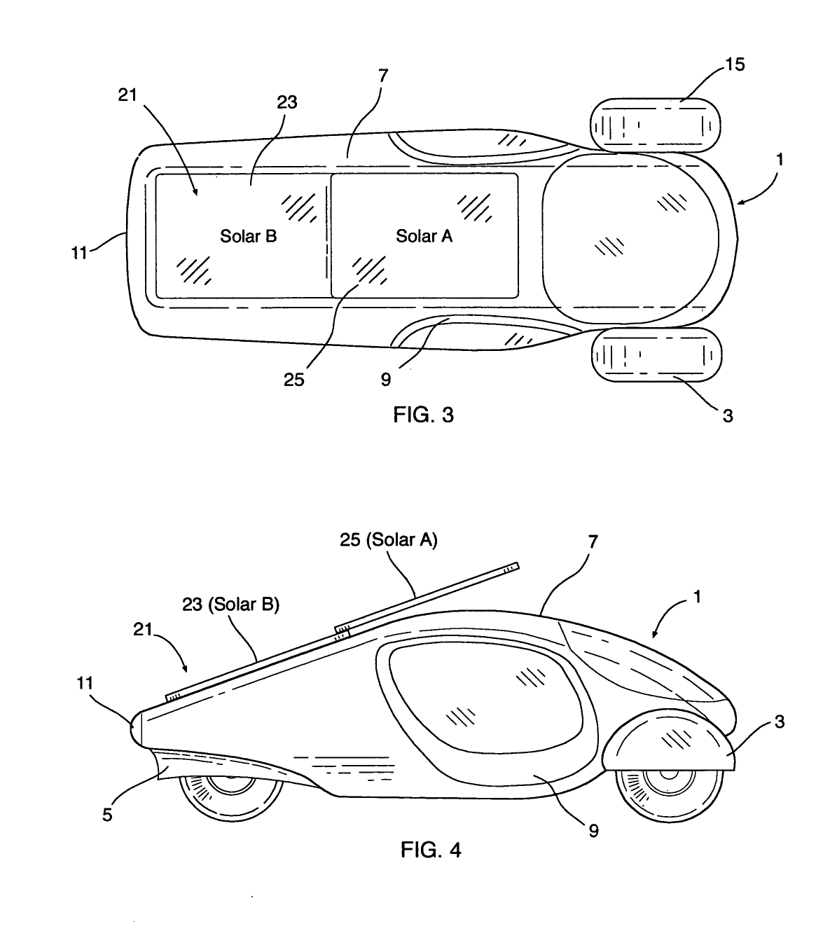

FIG. 3 shows the vehicle 1 with its front wheels 3 and 15. External body structure 7 and door 9 are also shown. The plurality of solar panels 21 is again shown in front of the rear bumper 11, and in FIG. 3 the solar panel marked Solar A 25 has been moved into a position forward of the solar panel marked Solar B 23. In one preferred embodiment, this repositioning is accomplished by sliding the solar panel marked Solar A 25 telescopically away from the solar panel marked Solar B 23. This telescopic sliding action is accomplished, for example, by attaching the solar panel marked Solar A 25 to a telescoping track (not shown), mating the telescoping track with a rail (not shown), and attaching the rail to either the external body structure 7 of the vehicle or to another solar panel. In one preferred embodiment, the movement of this plurality of solar panels 21 is done manually by a person. In another preferred embodiment, the telescoping sliding movement is done by a motor and gear (not shown). Alternatively, the sliding action could be accomplished through the use of pneumatic or hydraulic systems (not shown) attached to both the solar panel marked Solar A 25 and the external body structure of the vehicle 7. Such pneumatic or hydraulic systems would require a motor (not shown) to power a compressor or pump.

FIG. 4 shows a side view of the vehicle 1. This view shows the right front wheel 3 and the rear wheel 5. External body structure 7 is shown with door 9. Rear bumper 11 is shown. The plurality of solar panels 21 is shown with the solar panel marked Solar A 25 moved into a position forward of the solar panel marked Solar B 23. In the embodiment shown, the solar panel marked Solar A 25 is at approximately the same angle in the extended position as it is in the retracted position, but this is not always the case. In some embodiments, solar panels 21 will be at a different angle when in the second, open position than they are in the first, closed position.

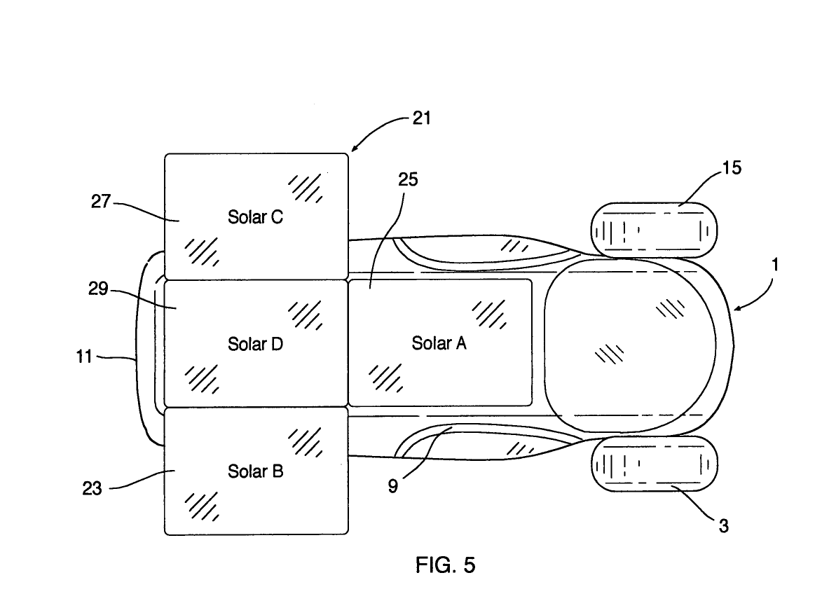

FIG. 5 shows the vehicle 1 with its plurality of solar panels 21 fully repositioned into their open configuration. This view of vehicle 1 shows both its left front wheel 15 and its right front wheel 3. External body structure 7 is shown along with door 9. The plurality of solar panels 21 lies in front of the rear bumper 11. The plurality of solar panels 21 is fully open into its second position. The solar panel marked Solar A 25 has been moved into a position forward of the solar panel marked Solar D 29. The solar panel marked Solar B 23 has been moved into a position to the right of the solar panel marked Solar D 29. The solar panel marked Solar C 27 has been moved to a position to the left of the solar panel marked Solar D 29. Although The solar panel marked Solar A 25, the solar panel marked Solar B 23, and the solar panel marked Solar C 27 have been moved, The solar panel marked Solar D 29 has remained stationary.

Although the solar panels 21 in FIG. 5 are shown to the left, right and front of the solar panel marked Solar D 29, it should be understood that the invention also embraces other configurations. In some preferred embodiments, the solar panels 21 extend beyond the rear of the vehicle. In other embodiments, all solar panels 21 extending beyond the footprint of the vehicle 1 are on the left side or the right side only. In some embodiments, the vehicle 1 has only one solar panel 21 extending beyond the footprint of the vehicle 1. In other preferred embodiments, the vehicle 1 can be equipped with as many solar panels 21 as the physical structure of the vehicle 1 can support.

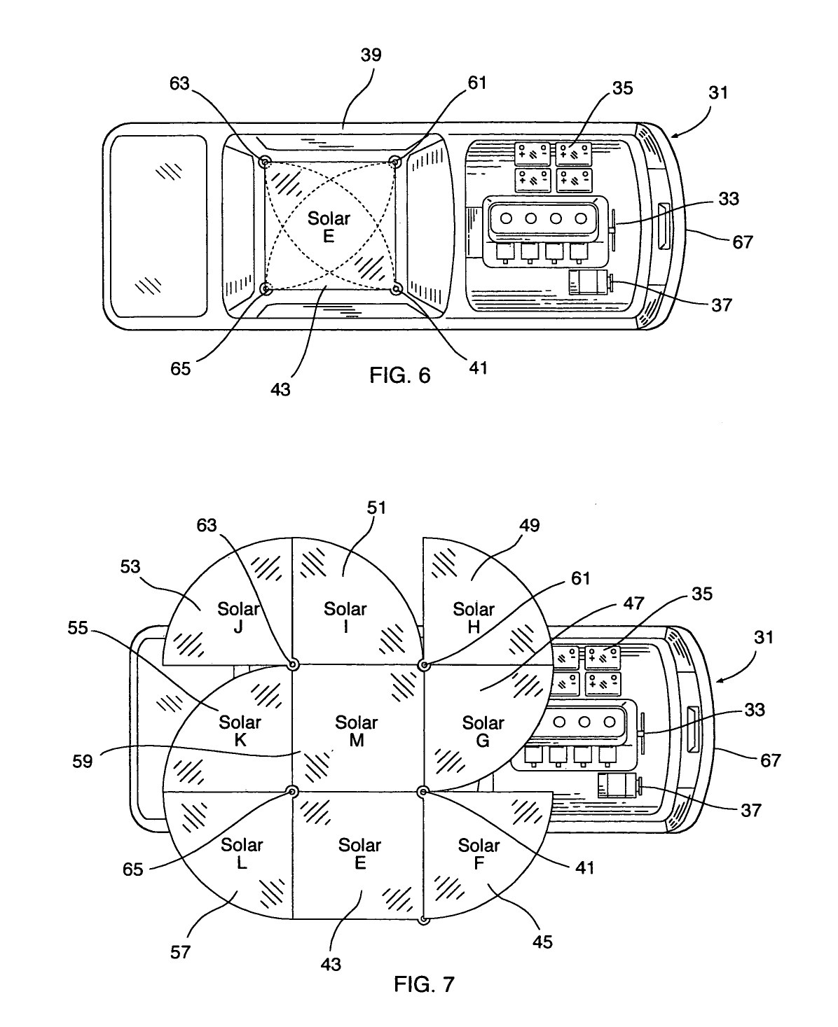

FIG. 6 shows another preferred embodiment of the present invention. A hybrid motor vehicle 31 is shown with its hood removed so that the internal combustion engine 33, a plurality of batteries 35 and an electric motor 37 are shown. Front bumper 67 is shown on the front of the vehicle 31. The vehicle 31 also has a post 41 connected to the external body structure 39. The solar panel marked Solar E 43 and seven other solar panels 45, 47, 49, 51 53, 55, 57 shown in FIG. 7 are rotatably connected to the post 41 or to three other posts 61, 63, 65. The solar panel marked Solar E 43 and eight other solar panels 45, 47, 49, 51 53, 55, 57, 59 are electrically connected to the plurality of batteries 35. In some preferred embodiments, the post 41 will be a different height than the other three posts not shown in order to facilitate rotation of the solar panels. The solar panels mounted to a higher post will be able to clear the lower posts and any solar panels mounted thereto. In other preferred embodiments, the posts are of equal height, and the edge of each solar panel is rounded to allow it to clear the other posts. In other embodiments, the posts are the same height, the corners of the solar panels are right angles, and each panel is sufficiently shortened to allow clearance past the other posts.

FIG. 7 shows the vehicle 31 of FIG. 6. The solar panels 43, 45, 47, 49, 51, 53, 55, 57, 59 have been moved to their second, open configuration. In this configuration, the four posts 41, 61, 63, and 65 are visible. The solar panel marked Solar E 43 and the solar panel marked Solar F 45 have been rotated clockwise around the first post 41. The solar panel marked Solar G 47 and the solar panel marked Solar H 49 have been rotated clockwise around the second post 61. The solar panel marked Solar I 51 and the solar panel marked Solar J 53 have been rotated clockwise around the third post 63. The solar panel marked Solar K 55 and the solar panel marked Solar L 57 have been rotated clockwise around the fourth post 65. The solar panel marked Solar M 59 does not move and is attached to the external body structure 39. The solar panel marked Solar E 43, the solar panel marked Solar G 47, the solar panel marked Solar I 51, and the solar panel marked Solar K 55 have each been rotated approximately 270 degrees from their first position about the posts 41, 61, 63, and 65 respectively. The solar panel marked Solar F 45, the solar panel marked Solar H 49, the solar panel marked Solar J 53, and the solar panel marked Solar L 57 have each been rotated approximately 180 degrees from their first position about the posts 41, 61, 63, and 65 respectively. In the most preferred embodiments, a rotational movement mechanism (not shown) is included to rotate the solar panels 43, 45, 47, 49, 51, 53, 55, 57. This rotational movement mechanism could be a motor, a pneumatic system, a hydraulic system, or a magnetic system. In other preferred embodiments, the solar panels 43, 45, 47, 49, 51, 53, 55, 57 are moved manually.

The preferred embodiment shown in FIG. 6 shows the solar panel marked Solar E 43 within the footprint of the vehicle 31 when in the first position. This is desirable when the vehicle 31 is in motion because any solar panels extending beyond the footprint of the vehicle 31 would be more likely to strike other objects when in motion. The solar panel marked Solar E 43 still faces upward in the closed position shown in FIG. 6. This is preferable because the solar panel marked Solar E could continue to generate limited amounts of electricity even in the closed position. When this preferred embodiment's solar panels 43, 45, 47, 49, 51, 53, 55, 57, 59 are in the second, open position, as in FIG. 7, the greater exposed surface area will generate more electricity, so opening the solar panels 43, 45, 47, 49, 51, 53, 55, 57, 59 when the vehicle 31 is stopped for extended periods is preferable.

In FIGS. 6 and 7, the posts 41, 61, 63, and 65 are of different heights. This is why only post 41 is visible in FIG. 6 and why the solar panels 43, 45, 47, 49, 51, 53, 55, 57 do not strike the posts 41, 61, 63, and 65 shown in FIG. 7 as the solar panels 43, 45, 47, 49, 51, 53, 55, 57 rotate outward. Although FIG. 6 shows post 41 to be the tallest, it should be understood that the choice of which post 41, 61, 63, and 65 is tallest is immaterial to the invention. Furthermore, the direction in which the solar panels rotate—that is, whether clockwise or counterclockwise—is also immaterial. It would be clear to one skilled in the art that, in preferred embodiments in which the panels rotate counter-clockwise, the posts will decrease in height clockwise. In preferred embodiments in which the panels rotate clockwise, the posts will decrease in height counter-clockwise.

It is possible to achieve a similar opened configuration shown in FIG. 7 with the solar panels attached to the posts differently. In this embodiment, the solar panel marked Solar F 45 and the solar panel marked Solar G 47 are both attached to the first post 41. The solar panel marked Solar H 49 and the solar panel marked Solar I 51 are both attached to the second post 61. The solar panel marked Solar J 53 and the solar panel marked Solar K 55 are both attached to the third post 63. The solar panel marked Solar L and the solar panel marked Solar E are both attached to the fourth post 65. The solar panel marked Solar M 59 does not move. The solar panel marked Solar F 45, the solar panel marked Solar H 49, the solar panel marked Solar J 53, and the solar panel marked Solar L 57 have each been rotated approximately 180 degrees clockwise from their original positions. The solar panel marked Solar E 43, the solar panel marked Solar G 47, the solar panel marked Solar I 51, and the solar panel marked Solar K 55 have each been rotated approximately 90 degrees clockwise from their original positions.

In another embodiment, it is possible to achieve a similar opened configuration shown in FIG. 7 with the solar panels rotating counter-clockwise. In this embodiment, the solar panel marked Solar F 45 and the solar panel marked Solar G 47 are both attached to the first post 41. The solar panel marked Solar H 49 and the solar panel marked Solar I 51 are both attached to the second post 61. The solar panel marked Solar J 53 and the solar panel marked Solar K 55 are both attached to the third post 63. The solar panel marked Solar L and the solar panel marked Solar E are both attached to the fourth post 65. The solar panel marked Solar M 59 does not move. The solar panel marked Solar E 43, the solar panel marked Solar G 47, the solar panel marked Solar I 51, and the solar panel marked Solar K 55 have each been rotated approximately 270 degrees counter-clockwise from their original positions. The solar panel marked Solar F 45, the solar panel marked Solar H 49, the solar panel marked Solar J 53, and the solar panel marked Solar L 57 have each been rotated approximately 180 degrees counter-clockwise from their original positions.

In yet another embodiment, it is possible to achieve a similar opened configuration shown in FIG. 7 with the solar panels rotating counter-clockwise. In this embodiment, the solar panel marked Solar E 43 and the solar panel marked Solar F 45 have been rotated counter-clockwise around the first post 41. The solar panel marked Solar G 47 and the solar panel marked Solar H 49 have been rotated counter-clockwise around the second post 61. The solar panel marked Solar I 51 and the solar panel marked Solar J 53 have been rotated counter-clockwise around the third post 63. The solar panel marked Solar K 55 and the solar panel marked Solar L 57 have been rotated counter-clockwise around the fourth post 65. The solar panel marked Solar M 59 does not move. The solar panel marked Solar F 45, the solar panel marked Solar H 49, the solar panel marked Solar J 53, and the solar panel marked Solar L 57 have each been rotated approximately 180 degrees counter-clockwise from their original positions. The solar panel marked Solar E 43, the solar panel marked Solar G 47, the solar panel marked Solar I 51, and the solar panel marked Solar K 55 have each been rotated approximately 90 degrees counter-clockwise from their original positions.

In still other embodiments, the design shown in FIG. 7 could have three panels, for example the solar panel marked Solar E 43, the solar panel marked Solar F 45, and the solar panel marked Solar G 47, attached to a single post 41. The opposite three panels, the solar panel marked Solar I 51, the solar panel marked Solar J 53, and the solar panel marked Solar K 55, would be attached to the opposite post 63. The solar panel marked Solar H 49 would be the only panel attached to post 61, and the solar panel marked Solar L 57 would be the only panel attached to post 65.

Likewise, the solar panel marked Solar G 47, the solar panel marked Solar H 49, and the solar panel marked Solar I 51 could be attached to a single post 61. The opposite three panels, the solar panel marked Solar K 55, the solar panel marked Solar L 57, and the solar panel marked Solar E 43 would be attached to the opposite post 65. The solar panel marked Solar F 45 would be the only panel attached to post 41, and the solar panel marked Solar J would be the only panel attached to post 63.

It may be necessary to change the shape of some or all of the solar panels 43, 45, 47, 49, 51, 53, 55, 57 to achieve the differently-connected embodiments just described. It would be clear to one skilled in the art how to make these modifications in a way that would allow all of the solar panels 43, 45, 47, 49, 51, 53, 55, 57 to fully open into the open configuration.

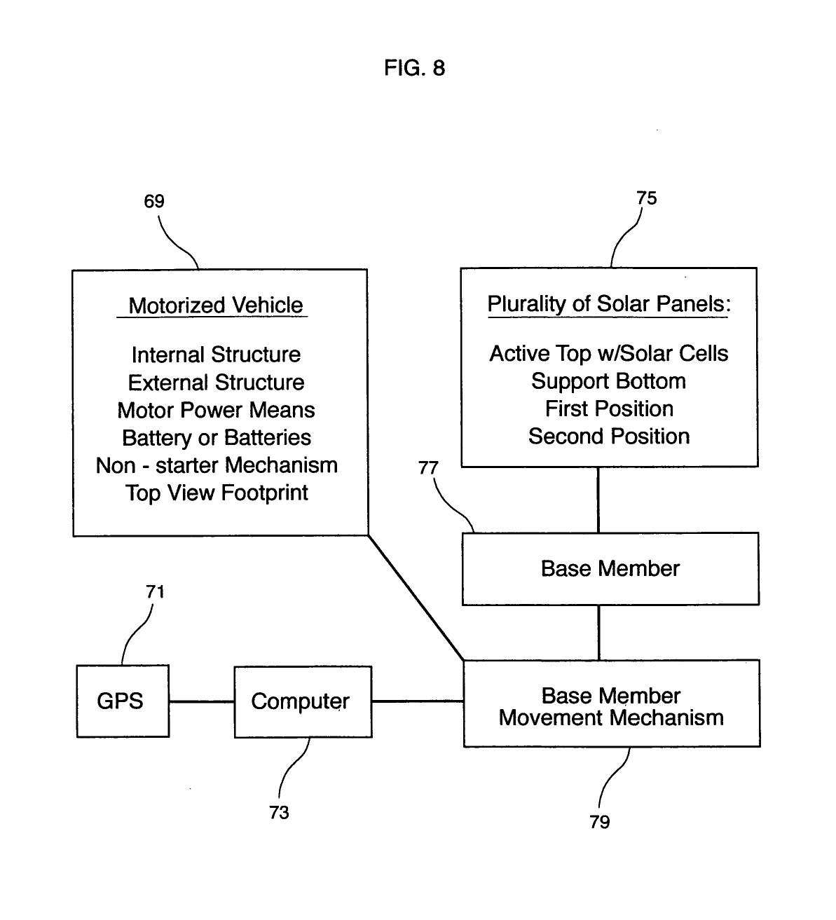

FIG. 8 shows a flowchart describing one preferred embodiment of the present invention. In this embodiment, there is a motorized vehicle 69 that has an internal structure and an external structure. This motorized vehicle 69 also has a motor power means and a battery that can be used to power at least one non-starter electronic device. The motorized vehicle 69 also has a top-view footprint when viewed from above. Attached to the motor vehicle 69 is a plurality of solar panels 75. The solar panels 75 each have an active top with solar cells and a support bottom. The solar panels 75 move between a first position and a second position. In this embodiment, the solar cells are attached to a base member 77 which provides further structural strength and support. This base member 77 is in turn connected to a base member movement mechanism 79 which changes the direction which the base member 77 is facing. The base member movement mechanism 79 is attached to the motorized vehicle 69 and to a computer 73. The computer 73 is attached to a GPS system 71. The GPS system 71, which is attached to the motorized vehicle 69, senses the position and orientation of the motorized vehicle 69. The GPS 73 sends this information to the computer 73 which determines the position of the sun relative to the motorized vehicle 69. In one preferred embodiment, the computer 73 calculates the position of the sun based on the position and orientation information of the motorized vehicle 69 obtained from the GPS 71, then uses an internal clock to determine the date and time; the computer 73 then determines the position of the sun based on this information. The computer 73 sends a signal to the base member movement mechanism 79. This signal causes the base member movement mechanism 79 to position the base member 77, and therefore the plurality of solar panels 75, in a sun-facing orientation. In some embodiments, the computer 73 is integrated into the GPS 71. In some embodiments the computer 73 will be in constant communication with the GPS 71 and the base member movement mechanism 79, allowing for constant adjustment of the base member 77. In other preferred embodiments, the computer 73 will cycle its communication to preserve power, and will move the plurality of solar panels 75 less frequently. For example, in one embodiment the computer 73 readjusts the panels 75 once per hour.

In some embodiments, the base member movement mechanism 79 for the base member 77 receives input from a solar tracker. In these embodiments, a solar tracking device (not shown) is included to determine from which direction the strongest sunlight is coming. The solar tracker then sends a signal to the base member movement mechanism 79 for the base member 77.

In other preferred embodiments, the base member 77 can be adjusted manually through a joystick or similar control (not shown). This joystick would send a signal to the base member movement mechanism 79. In other embodiments, a joystick can be used to control each of the plurality of solar panels 75 through a solar panel movement mechanism (not shown). In some preferred embodiments, a selector device (not shown), such as a number pad, is employed to change the functionality of the joystick and allow it to control each of the plurality of solar panels 75 independently.

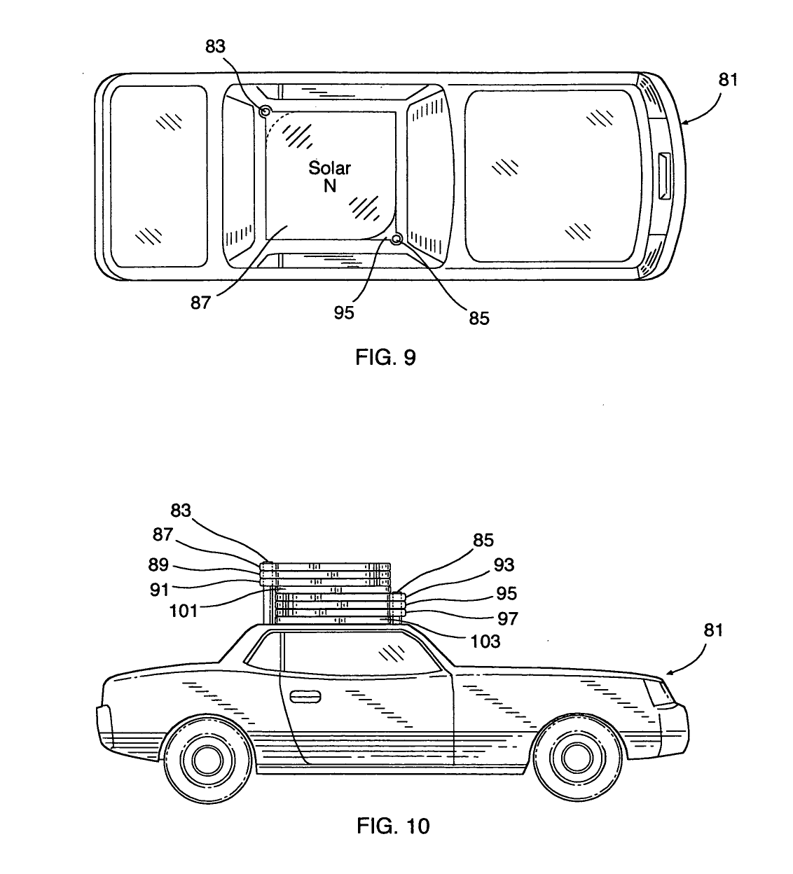

Referring now to FIGS. 9 through 12, wherein like reference numerals designate corresponding parts throughout the several views, it is to be understood that not all numbers appear in all figures. FIG. 9 shows another preferred embodiment of the invention. A vehicle 81 is shown with a first post 83 and a second post 85 attached. The solar panel marked Solar N 87 and two other rotatable solar panels not shown are rotatably attached to the post 83. The solar panel marked Solar R 95 and two other rotatable panels not shown are attached to post 85.

FIG. 10 shows another view of the preferred embodiment of FIG. 9. Vehicle 81 is shown in a side view with six rotatable solar panels 87, 89, 91, 93, 95, 97 and two telescoping solar panels shown 101, 103. The solar panel marked Solar N 87, the solar panel marked Solar O 89, and the solar panel marked Solar P 91 are each attached to the first post 83. The solar panel marked Solar Q 93, the solar panel marked Solar R 95, and the solar panel marked Solar S 97 are each attached to the second post 85. The telescoping panels, 101, 103, are shown underneath the rotating solar panels marked Solar P 91 and the solar panel marked Solar S 97. These telescoping solar panels 101, 103 would be attached to the rotating solar panels 91, 97 in a manner similar to the one described with reference to FIG. 3. In FIG. 10, the size of solar panels 87, 89, 91, 93, 95, 97, 99, 101, and 103 has been exaggerated to better show the relationship between the components.

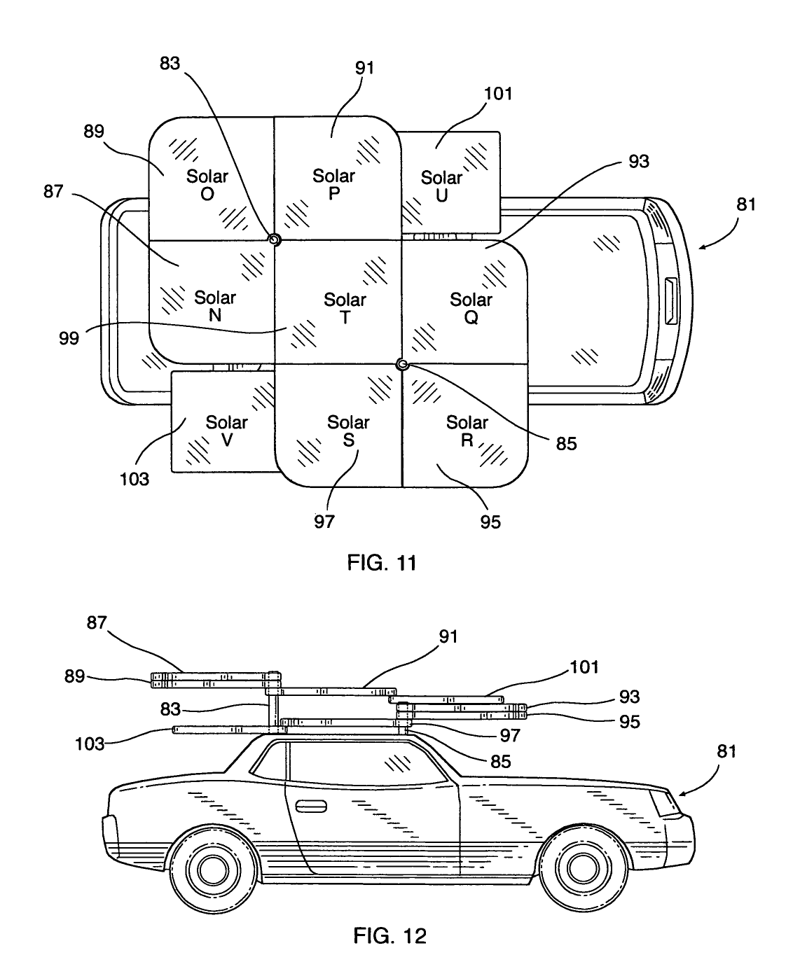

FIG. 11 shows another view of the preferred embodiment of FIG. 9. This top-down view shows the vehicle 81 with its solar panels 87, 89, 91, 93, 95, 97, 99, 101, and 103 opened into the second, open configuration. The solar panel marked Solar N 87, the solar panel marked Solar O 89, and the solar panel marked Solar P 91 are each attached to the first post 83. The solar panels 87, 89, 91 rotate counter-clockwise, so the solar panel marked Solar N 87 rotates approximately 270 degrees from its first, closed position. The solar panel marked Solar O 89 rotates counter-clockwise approximately 180 degrees from its first, closed position. The solar panel marked Solar P 91 rotates counter-clockwise approximately 90 degrees from its first, closed position. The solar panel marked Solar Q 93, the solar panel marked Solar R 95, and the solar panel marked Solar S 97 are each attached to the second post 85. The solar panels 93, 95, 97 rotate counter-clockwise, so the solar panel marked Solar Q 93 rotates approximately 270 degrees from its first, closed position. The solar panel marked Solar R 95 rotates counter-clockwise approximately 180 degrees from its first, closed position. The solar panel marked Solar S 97 rotates counter-clockwise approximately 90 degrees from its first, closed position. The solar panel marked Solar T 99 does not move.

FIG. 11 also shows a first telescoping solar panel, the solar panel marked Solar U 101 and a second telescoping solar panel, the solar panel marked Solar V 103. The solar panel marked Solar U 101 telescopes out from the solar panel marked Solar P 91. The solar panel marked Solar V 103 telescopes out from the solar panel marked Solar S 97. In this preferred embodiment, the telescoping panels allow an arrangement with only two posts, 83 and 85, in which nine solar panels 87, 89, 91, 93, 95, 97, 99, 101, and 103 are visible in the open, second configuration.

The arrangement shown in FIG. 11 is also possible with the panels rotating clockwise. In this embodiment, the solar panel marked Solar N 87, the solar panel marked Solar O 89, and the solar panel marked Solar P 91 are each attached to the first post 83. The solar panels 89, 91, 93 rotate clockwise, so the solar panel marked Solar P 91 rotates approximately 270 degrees from its first, closed position. The solar panel marked Solar O 89 rotates clockwise approximately 180 degrees from its first, closed position. The solar panel marked Solar N 87 rotates clockwise approximately 90 degrees from its first, closed position. The solar panel marked Solar Q 93, the solar panel marked Solar R 95, and the solar panel marked Solar S 97 are each attached to the second post 85. The solar panels 93, 95, 97 rotate clockwise, so the solar panel marked Solar S 97 rotates approximately 270 degrees from its first, closed position. The solar panel marked Solar R 95 rotates clockwise approximately 180 degrees from its first, closed position. The solar panel marked Solar Q 93 rotates clockwise approximately 90 degrees from its first, closed position. The solar panel marked Solar T 99 does not move. The solar panel marked Solar U 101 then telescopes out from the solar panel marked Solar P 91 and the solar panel marked Solar V 103 telescopes out from the solar panel marked Solar S 97.

FIG. 12 shows a side view of the preferred embodiment of the vehicle 81 shown in FIG. 9. The solar panel marked Solar N 87, the solar panel marked Solar O 89, and the solar panel marked Solar P 91 are shown as rotatably attached to the first post 83. The solar panel marked Solar Q 93, the solar panel marked Solar R 95, and the solar panel marked Solar S 97 are shown attached to the second post 85. The solar panel marked Solar U 101 is shown in its extended position, telescoped out from the solar panel marked Solar P 91. The solar panel marked Solar V 103 is shown in its extended position, telescoped out from the solar panel marked Solar S 97. In FIG. 12, the size of solar panels 87, 89, 91, 93, 95, 97, 101, and 103 has been exaggerated to better show the relationship between the components.

Although FIG. 12 shows the telescoping solar panel marked Solar U 101 and the telescoping solar panel marked Solar V 103 extending from the solar panel marked Solar P 91 and the solar panel marked Solar S 97 respectively, the telescoping solar panels 101, 103 may extend from any other panel, whether a rotating panel or a telescoping panel. Furthermore, although the solar panel marked Solar P 91 is the lowest rotating panel attached to the first post 83 and the solar panel marked Solar S 97 is the lowest rotating panel attached to the second post 85, telescoping panels may come out of any other panels, not merely the lowest panel attached to a post. If the telescoping panel is attached to the bottom of a rotating panel, sufficient space must be left underneath the rotating panel to provide clearance for the telescoping panel. The direction in which the telescoping panels extend is also immaterial.

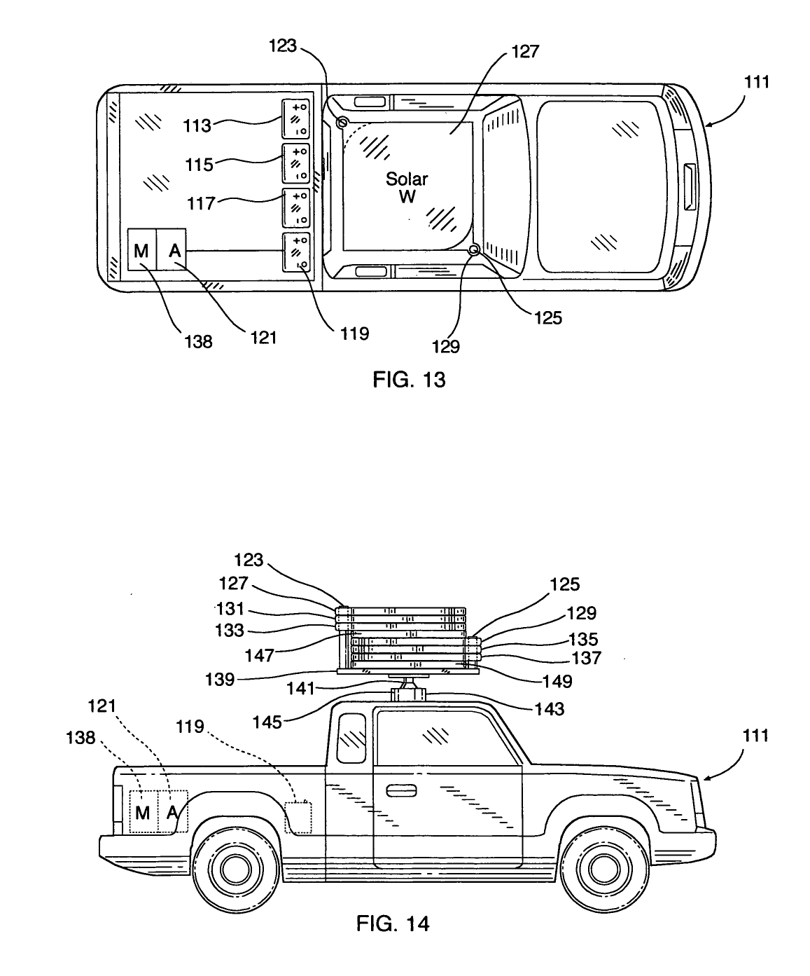

Referring now to FIGS. 13 through 15, wherein like reference numerals designate corresponding parts throughout the several views, it is to be understood that not all numbers appear in all figures. FIG. 13 shows another embodiment of the invention. A truck 111 is shown. This truck has four batteries 113, 115, 117, and 119. The truck also an electric motor M represented by 138 that supplies energy from the solar panels to an ancillary electronic component, such as an air compressor 121. To be more specific, the air compressor 121 is illustrates the idea that the solar panels 127, 129 can supply energy to the batteries 113, 115, 117, and 119, which in turn supply electricity to electronic components that are ancillary to the vehicle's systems such as air compressor 121. The use of a specific electronic component is meant as an illustration, not as a limitation, and it should be understood that any electronic component may be used in place of the air compressor 121. For example, electrical components of controls, converters and regulators may also be employed.

In addition, the truck 111 has a first post 123 and a second post 125. The solar panel marked Solar W 127 and two other solar panels not shown are attached to the first post 123. The solar panel marked Solar X 129 and two other panels not shown are attached to the second post 125.

FIG. 14 is a side view of the truck 111 shown in FIG. 13 with battery 119 and air compressor 121 visible. The solar panel marked Solar W 127, the solar panel marked Solar Y 131, and the solar panel marked Solar Z 133 are each attached to the first post 123. The solar panel marked Solar X 129, the solar panel marked Solar AA 135, and the solar panel marked Solar BB 137 are each attached to the second post 125. In operation, these six rotating solar panels 127, 129, 131, 133, 135, 137 would operate in the same manner as the solar panels shown in FIGS. 9 through 12. Thus, one telescoping panel 147 is located underneath the solar panel marked Solar Z 133. A second telescoping panels 149 would is located underneath the solar panel marked Solar BB 137. A base member movement mechanism 145 is located on truck 111. In FIG. 14, the size of the solar panels 127, 129, 131, 133, 135, 137, 147, 149, the base member 139, and the base member movement mechanism 145 have been exaggerated to better show the relation between the components. In preferred embodiments, these components are more streamlined and compact than those pictured. In other preferred embodiments, a windshield (not shown) is included in front of the solar panels, the base member 139, and the base member movement mechanism 145.

FIG. 14 also shows a base member 139 on which the first post 123 and the second post 125 are mounted. Underneath the base member is a base member support 141. This base member support 141 is pivotally attached to the vehicle 111 such that the base member support 141 can pivot in any direction. This may be accomplished with a universal join or similar mechanical device. A base member cowl 143 surrounds a drive system (not shown) that operates to pivot the base member support 141. In one preferred embodiment, a first motor (not shown) is adapted to drive the base member support 141 in a first approximately horizontal direction, while a second motor (not shown) is adapted to drive the base member support 141 in a perpendicular approximately horizontal direction. Some preferred embodiments include gears (not shown) between the motor and the base member support 141. In other preferred embodiments, a first pneumatic system (not shown) is adapted to drive the base member support 141 in one approximately horizontal direction, while a second pneumatic system (not shown) is adapted to drive the base member support 141 in a perpendicular approximately horizontal direction. These pneumatic systems include compressors (not shown). In another preferred embodiment, a first hydraulic system (not shown) is adapted to drive the base member support 141 in one approximately horizontal direction, while a second hydraulic system is adapted to drive the base member support 141 in a perpendicular approximately horizontal direction. These hydraulic systems include pumps (not shown). In another preferred embodiment, a first magnetic system is adapted to drive the base member support 141 in an approximately horizontal direction while a second magnetic system is adapted to drive the base member support 141 in a perpendicular approximately horizontal direction. The drive system may also be made from a combination of the systems just described. Other mechanisms suitable to move the base member support 141 will be clear to those having skill in the art.

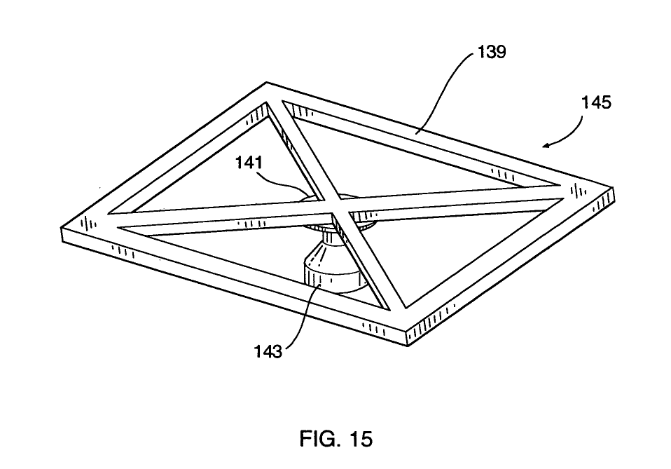

FIG. 15 shows an isolated view of the base member movement mechanism 145 illustrated in FIG. 14. A strong and preferably lightweight base member 139 is attached to a base member support 141. This base member support 141 extends downward through the base member cowl 143 where it attaches to a drive system as described in the preceding paragraph. In some preferred embodiments, the base member cowl 143 helps to protect the drive system and also limits the pivoting range of the base member support 141. In the most preferred embodiments, the base member cowl 143 is cylindrically shaped to allow the base member support 141 to pivot equally in all directions. In other embodiments, the base member cowl 143 is a polygonal prism. In other embodiments, the base member cowl 143 allows for x/y angle adjustment which may be provided by a joy stick. Together, the base member 139, the base member support 141, the base member cowl 143, and the drive system (not shown) make up the base support movement mechanism 145.

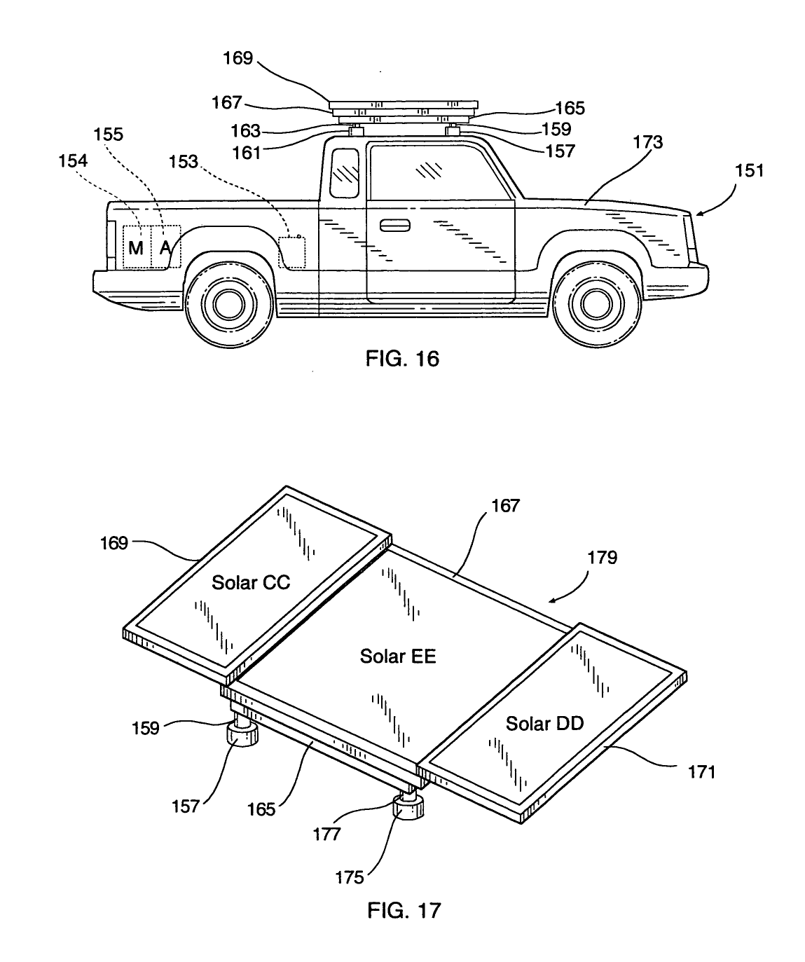

Referring now to FIGS. 16 through 17, wherein like reference numerals designate corresponding parts throughout the several views, it is to be understood that not all numbers appear in all figures. FIG. 16 shows another embodiment of the invention. An internal combustion vehicle 151 is shown with a non-starter battery 153 and an ancillary electronic device 155. The electronic device 155 is powered by the solar panels 169, 167, and 171 supplying energy to the batteries 154 through the motor supplying electricity to electronic components that are ancillary to the vehicle's systems such as electronic device. The use of a specific electronic component is meant as an illustration, not as a limitation, and it should be understood that any electronic component may be used such as air compressors, controls, converters and regulators.

The vehicle 151 has an external body structure 173. A first lower telescoping movement mechanism 157 and a second lower telescoping movement mechanism 161 are attached to the external body structure 173. Third and fourth lower telescoping movement mechanisms are also included, but not shown. In the most preferred embodiments, the vehicle 151 has four telescoping movement mechanisms. In other preferred embodiments, the vehicle 151 has only three telescoping movement mechanisms arranged in a triangle. In other embodiments, the vehicle has five or more telescoping movement mechanisms. Although the lower telescoping movement mechanisms 157, 161 are illustrated above the external body structure 173, in the most preferred embodiments the lower telescoping movement mechanisms 157, 161 are recessed to improve aesthetics or wind resistance. A first upper telescoping movement mechanism 159 is movably attached to the first lower telescoping movement mechanism 157. A second upper telescoping movement mechanism 163 is movably attached to the second lower telescoping movement mechanism 161. Third and fourth upper telescoping movement mechanisms are movably connected to third and fourth lower telescoping movement mechanisms respectively, but are not shown in this view. In this way, the upper telescoping movement mechanisms 159, 163 and the lower telescoping movement mechanisms 157, 161 form an elevator. In other embodiments of the present invention, the elevator may be a piston selected from the group consisting of hydraulic, pneumatic, mechanical, or magnetic. The elevator may be an any way lift or a worm lift. A base member 165 is attached to each of the first upper telescoping movement mechanism 159, the second upper telescoping movement mechanism 163, the third upper telescoping movement mechanism, not shown, and the fourth upper telescoping movement mechanism, not shown. A single elevator may be used to move the base member 165 or a plurality of elevators may be used as in the present embodiment of the invention. The independent movement of these telescoping movement mechanisms 159, 163 up and down changes the angle of the base member 165. In this embodiment, a universal joint is part of each upper telescoping movement mechanism 159, 163 so that as the telescoping movement mechanisms move up and down and the angle of the base member 165 changes, the base member 165 will remain in constant contact with each of the telescoping movement mechanisms while allowing the base member 165 to move.

The solar panel marked Solar EE 167 is attached to the base member 165. The solar panel marked Solar CC 169 is telescopically attached to the solar panel marked Solar EE 167. The solar panel marked Solar DD, not shown, is also telescopically attached to the solar panel marked Solar EE 167.

FIG. 17 shows a front perspective view of the solar array 179 from FIG. 16. In this view, the first lower telescoping movement mechanism 157 and the third lower telescoping movement mechanism 175 are visible; however, the second lower telescoping movement mechanism and the fourth telescoping movement mechanism are not shown. The first upper telescoping movement mechanism 159 is movably attached to the first lower telescoping movement mechanism 157. The third upper telescoping movement mechanism 177 is movably attached to the third lower telescoping movement mechanism 175. The second and fourth upper telescoping movement mechanisms, not shown, are movably attached to the second and fourth lower telescoping movement mechanisms, not shown. The first upper telescoping movement mechanism 159 and the third upper telescoping movement mechanism 177, along with second and fourth upper telescoping movement mechanisms, not shown, are attached to the base member 165. The solar panel marked Solar EE 167 is attached to the base member 165. The solar panel marked Solar CC 169 is telescopically attached to the solar panel marked Solar EE 167. The solar panel marked Solar DD 171 is telescopically attached to the solar panel marked Solar EE 167. Transitioning the solar panels 167, 169, 171 can be accomplished as described in the above paragraphs.

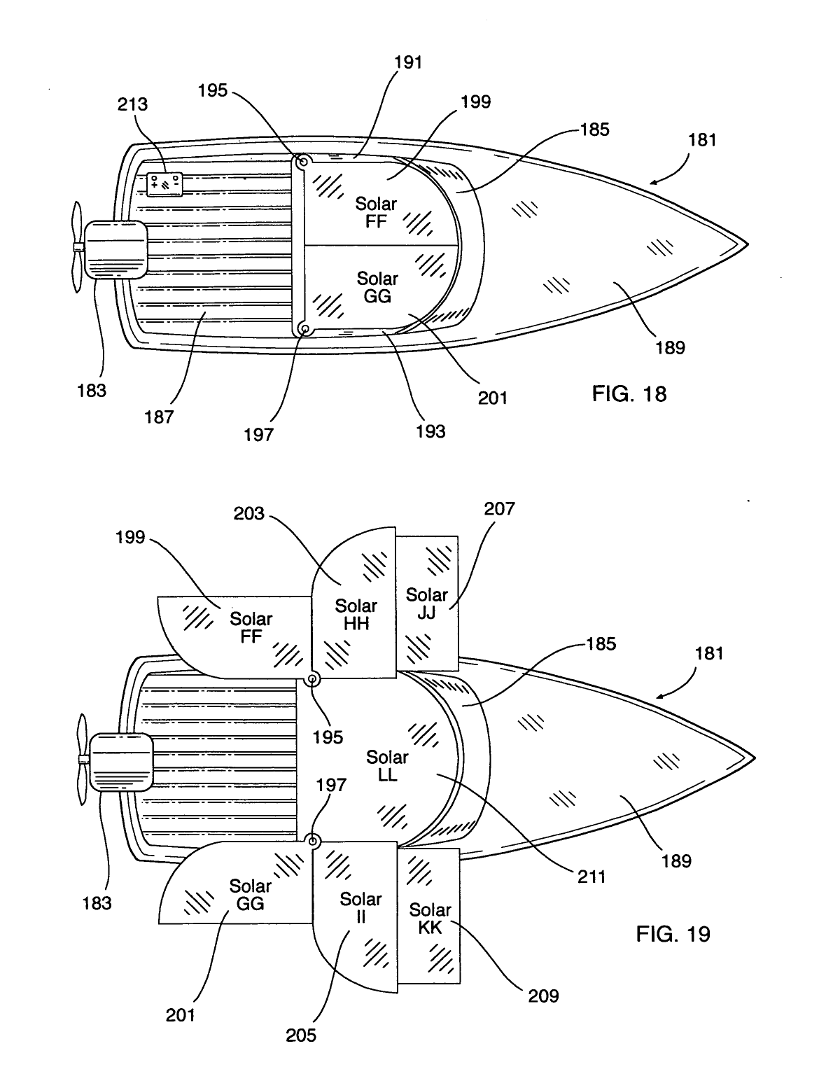

Referring now to FIGS. 18 through 19, wherein like reference numerals designate corresponding parts throughout the several views, it is to be understood that not all numbers appear in all figures. FIG. 18 shows another embodiment of the invention. Motorized water vehicle 181 has a motor 183, a windshield 185, an internal space 187, and an external body structure 189. The vehicle 181 has a left window 191 and a right window 193. A first post 195 is attached to the external body structure 189. A second post 197 is attached to the external body structure 189. The solar panel marked Solar FF 199 is rotatably attached to the first post 195. The solar panel marked Solar GG 201 is rotatably attached to the second post 197. The motorized water vehicle 181 also has at least one battery 213 that is used to power at least one non-starter electronic device not shown, such as a coffee maker or mini-fridge. In some embodiments this at least one battery 213 is partially charged by solar energy supplied from the solar panels 199, 201 and partially charged through mechanical energy from the motor 183.

FIG. 19 shows another view of the embodiment of the present invention shown in FIG. 18 on motorized water vehicle 181 with motor 183, windshield 185, internal space 187 and external body structure 189, and with the solar panels 199, 201, 203, 205, 207, 209 in a second, opened configuration. In this figure, the solar panel marked Solar FF 199 is rotatably attached to first post 195 and has been rotated 180 degrees counter-clockwise. The solar panel marked Solar GG 201 is rotatably attached to second post 197 and has been rotated 180 degrees clockwise. The solar panel marked Solar HH 203 is rotatably attached to first post 195 and has been rotated 90 degrees counter-clockwise. The solar panel marked Solar II 205 is rotatably attached to the second post 197, and has been rotated 90 degrees clockwise. The solar panel marked Solar JJ 207 is telescopically attached to the solar panel marked Solar HH 203 and has been extended to the full range of its telescoping movement. The solar panel marked Solar KK 209 is telescopically attached to the solar panel marked Solar II 205 and has been extended to the full range of its telescoping movement. The solar panel marked Solar LL 211 is attached to external body structure 189.

To summarize, the present invention thus provides a motorized vehicle with expanded solar capacity. By having a vehicle with solar panels that point upward in the closed position and that can be opened into an opened configuration when the vehicle is at rest, the vehicle can produce more energy to power the vehicle's systems. The two positions provided by the present invention allow for decreased impact on the vehicle while the vehicle is moving with the solar panels in the first, closed position and increased electricity production when the vehicle is at rest with the solar panels in the second, open position.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A motorized vehicle having a plurality of solar panels for charging at least one battery, which comprises:
a) a motorized vehicle having motor power means and having an internal structure to accommodate at least one person, and having an external body structure, said motorized vehicle having a predetermined top-view footprint;
b) at least one storage battery having a capacity in excess of said motorized vehicle starting requirements and adapted to power at least one non-starter mechanism;
c) a plurality of solar panels having an active solar cell top and a solar cell support bottom, at least one of said plurality of solar panels physically connected to said external body structure of said motor vehicle and electrically connected to said at least one storage battery; said plurality of solar panels having a first position and a second position wherein at least one of said plurality of solar panels is positioned within said footprint in first position and at least one of said plurality of solar panels extends beyond said footprint in said second position, wherein said active solar cell top of all of said plurality of solar panels face upwardly in both said first position and said second position; and
d) a solar panel movement mechanism for moving at least one of said plurality of solar panels from said first position to said second position and from said second position to said first position.

2. The motorized vehicle having a plurality of solar panels for charging at least one battery of claim 1 wherein said solar panel movement mechanism includes a drive mechanism selected from the group consisting of pneumatic, hydraulic, mechanical, or magnetic drive mechanisms and combinations thereof.

3. The motorized vehicle having a plurality of solar panels for charging at least one battery of claim 1 wherein said solar panel movement mechanism is a rotational movement mechanism that moves solar panels from said first position to said second position.

4. The motorized vehicle having a plurality of solar panels for charging at least one battery of claim 1 further comprising at least one post mounted on said exterior body structure of said motor vehicle, wherein at least one of said plurality of solar panels is rotatably attached to said at least one post.

5. The motorized vehicle having a plurality of solar panels for charging at least one battery of claim 1 wherein said solar panel movement mechanism is a telescopic movement mechanism that moves solar panels from said first position to said second position.

6. The motorized vehicle having a plurality of solar panels for charging at least one battery of claim 1 wherein each solar panel of said plurality is positioned over one another in said first position.

7. The motorized vehicle having a plurality of solar panels for charging at least one battery of claim 1 further comprising a first and second post mounted on said exterior body structure of the motor vehicle, wherein said at least one solar panel comprises two or more solar panels, wherein said two or more solar panels are divided into a first and a second group, said first group rotatably attached to said first post, and said second group rotatably attached to said second post.

8. The motorized vehicle having a plurality of solar panels for charging at least one battery of claim 1 further comprising a plurality of posts mounted on the exterior body structure of the motor vehicle, wherein the plurality of solar panels comprises a plurality of groups, said plurality of groups rotatably attached to said plurality of posts.

9. The motorized vehicle having a plurality of solar panels for charging at least one battery of claim 1 wherein an ancillary electronic device is connected to said at least one storage battery wherein electricity is supplied to said ancillary electronic device through said plurality of solar panels generating electricity through said at least one storage battery.

10. The motorized vehicle having a plurality of solar panels for charging at least one battery of claim 1 further comprising:
a base member attached to said solar cell support bottom of least one of said plurality of solar panels; and
at least one base member movement mechanism having a top attached to said base member and a bottom attached to said external body structure of said motor vehicle.

11. The motorized vehicle having a plurality of solar panels for charging at least one battery of claim 10 wherein said base member movement mechanism is adapted to rotate said base member along at least two axes.

12. A motorized vehicle having a plurality of solar panels for charging at least one battery, which comprises:
a) a motorized vehicle having motor power means and having an internal structure to accommodate at least one person, and having an external body structure, said motorized vehicle having a predetermined top-view footprint;
b) at least one storage battery having a capacity in excess of said motorized vehicle starting requirements and adapted to power at least one non-starter mechanism;
c) a plurality of solar panels having an active solar cell top and a solar cell support bottom, at least one of said plurality of solar panels physically connected to said external body structure of said motor vehicle and electrically connected to said at least one storage battery; said plurality of solar panels having a first position and a second position wherein at least one of said plurality of solar panels is positioned within said footprint in first position and at least one of said plurality of solar panels extends beyond said footprint in said second position, wherein said active solar cell top of all of said plurality of solar panels face upwardly in both said first position and said second position;
d) a solar panel movement mechanism for moving at least one of said plurality of solar panels from said first position to said second position and from said second position to said first position; and
e) a solar panel angle adjustment mechanism attached to at least one of said plurality of solar panels for adjusting the X, Y and Z axis angles of at least one of said plurality of solar panels to enhance solar orientation.

13. The motorized vehicle having a plurality of solar panels for charging at least one battery of claim 12 wherein said solar panel movement mechanism includes a drive mechanism selected from the group consisting of pneumatic, hydraulic, mechanical, or magnetic drive mechanisms and combinations thereof.

14. The motorized vehicle having a plurality of solar panels for charging at least one battery of claim 12 wherein said solar panel movement mechanism is a rotational movement mechanism that moves solar panels from said first position to said second position.

15. The motorized vehicle having a plurality of solar panels for charging at least one battery of claim 12 further comprising at least one post mounted on said exterior body structure of said motor vehicle, wherein at least one of said plurality of solar panels is rotatably attached to said at least one post.

16. The motorized vehicle having a plurality of solar panels for charging at least one battery of claim 12 wherein said solar panel movement mechanism is a telescopic movement mechanism that moves solar panels from said first position to said second position.

17. The motorized vehicle having a plurality of solar panels for charging at least one battery of claim 12 wherein each solar panel of said plurality is positioned over one another in said first position.

18. The motorized vehicle having a plurality of solar panels for charging at least one battery of claim 12 further comprising a first and second post mounted on said exterior body structure of the motor vehicle, wherein said at least one solar panel comprises two or more solar panels, wherein said two or more solar panels are divided into a first and a second group, said first group rotatably attached to said first post, and said second group rotatably attached to said second post.

19. The motorized vehicle having a plurality of solar panels for charging at least one battery of claim 12 further comprising a plurality of posts mounted on the exterior body structure of the motor vehicle, wherein the plurality of solar panels comprises a plurality of groups, said plurality of groups rotatably attached to said plurality of posts.

20. The motorized vehicle having a plurality of solar panels for charging at least one battery of claim 12 wherein an ancillary electronic device is connected to said at least one storage battery wherein electricity is supplied to said ancillary electronic device through said plurality of solar panels generating electricity through said at least one storage battery.

21. The motorized vehicle having a plurality of solar panels for charging at least one battery of claim 12 further comprising:
a base member attached to said solar cell support bottom of least one of said plurality of solar panels; and
at least one base member movement mechanism having a top attached to said base member and a bottom attached to said external body structure of said motor vehicle.

22. The motorized vehicle having a plurality of solar panels for charging at least one battery of claim 21 wherein said base member movement mechanism is adapted to rotate said base member along at least two axes.

23. A motorized vehicle having a plurality of solar panels for charging at least one battery which comprises:
a) a motorized vehicle having a motor power means and having an internal structure to accommodate at least one person, and having an external body structure, said motorized vehicle having a predetermined top-view footprint;
b) at least one storage battery having a capacity in excess of said motorized vehicle starting requirements and adapted to power at least one starter mechanism.
c) a plurality of solar panels movably connected to said external body structure of said motor vehicle and electrically connected to said storage battery, each of said plurality of solar panels having a top, wherein each said top of said plurality of solar panels is oriented skyward; said plurality of solar panels having a first position and a second position wherein said plurality of solar panels remains within said footprint in first position and said plurality of solar panels extends beyond said footprint in said second position;
d) mechanism means for moving the at least one solar panel from said first position to said second position and from said second position to said first position; and
e) means for automatically adjusting the angle of at least one of said plurality of solar panels.

24. The motorized vehicle having a plurality of solar panels for charging at least one battery of claim 23 wherein said means for automatically adjusting the angle comprises:
an angle-adjustment means for adjusting the angle of said at least one of said plurality of solar panels;
a global positioning system connected to said vehicle, said global positioning system adapted to determining the position and orientation of said vehicle;
a computer, computationally connected between said global positioning system and said angle-adjustment means, said computer adapted to receive input, determine the position of the sun based on said input, and output to said angle-adjustment means;
a clock computationally connected to said computer; and
a calendar computationally connected to said computer.

25. The motorized vehicle having a plurality of solar panels for charging at least one battery of claim 23 wherein said means for automatically adjusting the angle comprises:
an angle-adjustment means for adjusting the angle of said at least one of said plurality of solar panels; and
a computer computationally connected to said angle-adjustment means and said plurality of solar panels, said computer adapted to receive input from said plurality of solar panels, determine the position of the sun based on said input, and output to said angle-adjustment means.

26. In combination, a motorized vehicle and a plurality of solar panels for charging batteries which comprises:
a) a motorized vehicle having a motor power means and having an internal structure to accommodate at least one person, and having an external body structure, said motorized vehicle having a predetermined top-view footprint;
b) a base support connected to said external body structure;
c) at least one storage battery connected to said motorized vehicle, said battery having a capacity in excess of said motorized vehicle starting requirements and adapted to power at least one starter mechanism.
d) a plurality of solar panels movably connected to said base support and electrically connected to said storage battery, each of said plurality of solar panels having a top and a bottom, wherein each said top of said plurality of solar panels is oriented skyward; said plurality of solar panels having a first position and a second position wherein said plurality of solar panels remains within said footprint in first position and said plurality of solar panels extends beyond said footprint in said second position;
e) mechanism means for moving the at least one solar panel from said first position to said second position and from said second position to said first position; and
f) means for automatically adjusting the angle of at least one of said plurality of solar panels.

27. The combination of claim 26 wherein said base support comprises:
i) a baseplate having a top adapted to receive said plurality of solar panels, and a bottom;
ii) an upper universal joint having a top and a bottom, said top of said upper universal joint attached to said bottom of said baseplate; and,
iii) at least one elevator having a top and a bottom; said top of said at least one elevator attached to said bottom of said upper universal joint, said bottom of said elevator attached to said external body structure.

28. The combination of claim 27 wherein said at least one elevator comprises at least one piston.

29. The combination of claim 28 wherein said piston is selected from the group consisting of hydraulic, pneumatic, mechanical, or magnetic.

30. The combination of claim 28 further comprising a means for moving said upper universal joint, wherein said at least one elevator comprises a single central elevator.

31. The combination of claim 30 wherein said means for moving said upper universal joint is selected from the group consisting of manual control and automatic control.
